(19) United States
(12) Patent Application Publication
(10) Pub. No.: US 2025/0087029 A1
(43) Pub. Date: Mar. 13, 2025

(54) METHOD AND SYSTEM FOR GENERATING REPAIR RECOMMENDATIONS FOR VEHICLES

(71) Applicant: CAROTA Technology Corporation, Shanghai (CN)

(72) Inventor: Xinjie ZHANG, Shanghai (CN)

(73) Assignee: CAROTA Technology Corporation, Shanghai (CN)

(21) Appl. No.: 18/934,143

(22) Filed: Oct. 31, 2024

(30) Foreign Application Priority Data
Oct. 22, 2024 (CN) 202411479633.5

(51) Int. Cl. G07C 5/00; G07C 5/02; G07C 5/10

(52) U.S. Cl. CPC G07C 5/008; G07C 5/02; G07C 5/10

(57) ABSTRACT

A method for generating repair recommendations for vehicles, comprises (S1) collecting a real-time operating data of the vehicle in response to a fault diagnosis request and transmitting the real-time operating data to a cloud server; (S2) the cloud server performing a fault diagnosis on the vehicle based on the real-time operating data to generate a comprehensive fault diagnosis result and a comprehensive repair recommendation; and (S3) the cloud server generating a customized repair plan for the vehicle and transmitting the customized repair plan to a requester of the fault diagnosis request, the customized repair plan comprising the comprehensive fault diagnosis result and the comprehensive repair recommendation. The method of the disclosure takes into account the model, batch and historical fault data of the vehicle, thereby enhancing the accuracy of fault diagnosis, reducing repair time and cost, and improving the efficiency of vehicle repair.

### CROSS-REFERENCE TO RELATED APPLICATIONS

This application claims priority to Chinese patent application No. 202411479633.5, filed on Oct. 22, 2024, the contents of which are incorporated herein by reference.

### TECHNICAL FIELD

The disclosure relates generally to automated fault diagnosis for vehicles, particularly to method and system for generating repair recommendations for vehicles.

### BACKGROUND

The technology for remote vehicle fault diagnosis leverages communication technology and big data analytics to enable real-time monitoring and faults diagnosis in vehicles. On-board sensors can collect operating data and real-time status information of various subsystems/components of the vehicle. This data can be transmitted to a cloud server in real time via a data transmission module, such as a wireless network or a cellular network. At the cloud server, specialized analytics software processes and analyzes the data to identify potential faults. A vehicle fault diagnosis report can be transmitted to, for example, a smartphone application or a vehicle dashboard, allowing users or automotive mechanics to view the vehicle's status and receive fault alerts. The vehicle fault diagnosis report can detail such as a type of fault, a location of fault, a severity, an impact extent, and feasible repair recommendation(s). The automotive mechanic can then perform repairs based on the repair recommendations provided in the diagnostic report.

In existing vehicle fault diagnosis approaches, the diagnosis is primarily based on fault codes, without considering the fault's origin, location, or historical repair plans. However, for specific vehicles, depending on their model and production batch, common faults can be concentrated in particular components or software. Additionally, based on the user's operating habits and customized settings, recurring faults often follow certain patterns, meaning previously occurred faults are more likely to reoccur. The existing fault diagnosis approaches do not incorporate this historical fault information.

Furthermore, the repair recommendations in existing vehicle fault diagnosis approaches are primarily directed at automotive mechanics and do not consider faults caused by improper driver operation or defects in the vehicle's software system. Consequently, the existing vehicle fault diagnosis approaches do not provide operational recommendations for drivers or suggestions for software and hardware design improvements to vehicle manufacturers.

### SUMMARY

A first aspect of the disclosure provides a method for generating a repair recommendation for a vehicle. In some embodiments, the method can comprise (S1) collecting a real-time operating data of the vehicle in response to a fault diagnosis request and transmitting the real-time operating data to a cloud server; (S2) the cloud server performing a fault diagnosis on the vehicle based on the real-time operating data to generate a comprehensive fault diagnosis result and a comprehensive repair recommendation; and (S3) the cloud server generating a customized repair plan for the vehicle and transmitting the customized repair plan to a requester of the fault diagnosis request, the customized repair plan comprising the comprehensive fault diagnosis result and the comprehensive repair recommendation. In some embodiments, the step (S3) can comprise (S21) performing a historical fault diagnosis on the vehicle based at least in part on the real-time operating data to generate a first fault diagnosis result Res1 and a first repair recommendation Sug1, and/or (S22) performing a real-time fault diagnosis on the vehicle based at least in part on the real-time operating data to generate a second fault diagnosis result Res2 and a second repair recommendation Sug1; (S23) generating the comprehensive fault diagnosis result, the comprehensive fault diagnosis result comprising the first fault diagnosis result Res1 and/or the second fault diagnosis result Res2; and (S24) generating the comprehensive repair recommendation. The comprehensive repair recommendation can comprise the first repair recommendation Sug1 and/or the second repair recommendation Sug2. In some embodiments, the comprehensive repair recommendation can be categorized into an operational guidance recommendation, a hardware repair recommendation and a software/hardware improvement recommendation using a repair recommendation classifier.

In some embodiments, a historical fault table Ta, a production batch-related fault table Tb and a model-related fault table Tc of the vehicle can be stored and updated in the cloud server. The historical fault diagnosis can be performed sequentially using a historical fault information of the vehicle, a historical fault information of a production batch of the vehicle, and a historical fault information of a model of the vehicle in this order.

In some embodiments, when a historical fault is determined to have reoccurred, a fault count corresponding to the historical fault can be updated in the historical fault table Ta. When a production batch-related fault is determined to have reoccurred, a fault count corresponding to the production batch-related fault can be updated in the production batch-related fault table Tb. When a model-related fault is determined to have reoccurred, a fault count corresponding to the model-related fault can be updated in the model-related fault table Tc.

In some embodiments, the historical fault diagnosis can be performed for faults having a fault count or frequency exceeding a threshold in the historical fault table Ta, the production batch-related fault table Tb or the model-related fault table Tc.

In some embodiments, the historical fault diagnosis and/or the real-time fault diagnosis can be further performed based on a dynamic data, the dynamic data comprising a driving behavior data and/or an environmental data.

In some embodiments, the historical fault table Ta can store therein a license plate number, a production batch, a model, a fault information, a fault count, an abnormal operation data, a location of fault, a source of fault and a repair recommendation corresponding to the fault information. In some embodiments, the production batch-related fault table Tb can store therein a production batch, a fault information, a fault count, an abnormal performance, a source of fault and a repair recommendation. In some embodiments, the model-related fault table Tc can store therein a model, a fault information, a fault count, an abnormal performance, a source of fault and a repair recommendation.

In some embodiments, the second fault diagnosis result Res2 can comprise an abnormal operation data, a location of fault, a possible source of fault. The second repair recommendation Sug2 can comprise a description of fault symptom, an image of faulty component, a description of repair approach, a video of repair approach and any combination thereof.

In some embodiments, the comprehensive repair recommendation can be transmitted to the requester of the fault diagnosis request along with the comprehensive fault diagnosis result. In some embodiments, the comprehensive fault diagnosis result and the operational guidance recommendation can be transmitted to a user of the vehicle, the comprehensive fault diagnosis result and the hardware repair recommendation can be transmitted to an automotive mechanic of the vehicle, and the comprehensive fault diagnosis result and the software/hardware improvement recommendation can be transmitted to a manufacturer of the vehicle.

In some embodiments, the method can further comprises utilizing a big data analytics to update the production batch-related fault table Tb and the model-related fault table Tc of the vehicle in the cloud server.

In some embodiments, the production batch-related fault table Tb and the model-related fault table Tc can be generated by aggregating data from the historical fault table Ta.

In some embodiments, a machine learning algorithm can be utilized to adjust the threshold in real time based on changes in an operating environment of the vehicle and/or an actual operating condition of the vehicle.

In some embodiments, if the historical fault diagnosis identifies a fault that is identical to a historical fault, the real-time fault diagnosis can be bypassed.

In some embodiments, a decision to perform the real-time fault diagnosis can be based on a usage of the vehicle or feedback from a user of the vehicle.

In some embodiments, the method can further comprises collecting a user feedback to dynamically update the repair recommendation classifier.

In some embodiments, the method can further comprise removing duplicate or invalid data in the first fault diagnosis result Res1 and the second fault diagnosis result Res2 and/or the first repair recommendation Sug1 and the second repair recommendation Sug2 by using a data cleaning or a feature selection.

In some embodiments, the method can further comprises integrating the first fault diagnosis result Res1 and the second fault diagnosis result Res2 and/or the first repair recommendation Sug1 and the second repair recommendation Sug2 into a global view by a multi-source data fusion.

In some embodiments, the method can further comprises generating the customized repair plan based on the comprehensive fault diagnosis result, a severity and a type of current fault, and a dynamic data, the dynamic data comprising a driving behavior data and/or an environmental data.

In some embodiments, the dynamic data can be received from a sensor system of the vehicle and/or an external data source.

A second aspect of the disclosure provides a system comprising one or more computer processors and a computer readable memory, the computer readable memory comprising machine executable code, which when executed by the one or more computer processors implements the method for generating repair recommendations for a vehicle of the disclosure.

### BRIEF DESCRIPTION OF THE DRAWINGS

The novel features of the disclosure are set forth with particularity in the appended claims. A better understanding of the features and advantages of the disclosure will be obtained by reference to the following detailed description that sets forth illustrative embodiments, in which the principles of the disclosure are utilized, and the accompanying drawings.

FIG. 1 is a flow chart of a method for generating repair recommendations for vehicle according to an embodiment of the present application.

FIG. 2 is a flow chart of a method for generating comprehensive fault diagnosis results and comprehensive repair recommendation according to an embodiment of the present application.

### DETAILED DESCRIPTION

To address the issue where existing vehicle fault diagnosis systems only consider component fault information and overlook common problems related to the vehicle model and production batch, leading to less targeted repair recommendations, this disclosure provides a method for generating vehicle repair recommendations which incorporates the vehicle model, production batch, and historical fault data, thereby enhancing the accuracy of fault diagnosis, reducing repair time and costs, and improving overall vehicle repair efficiency.

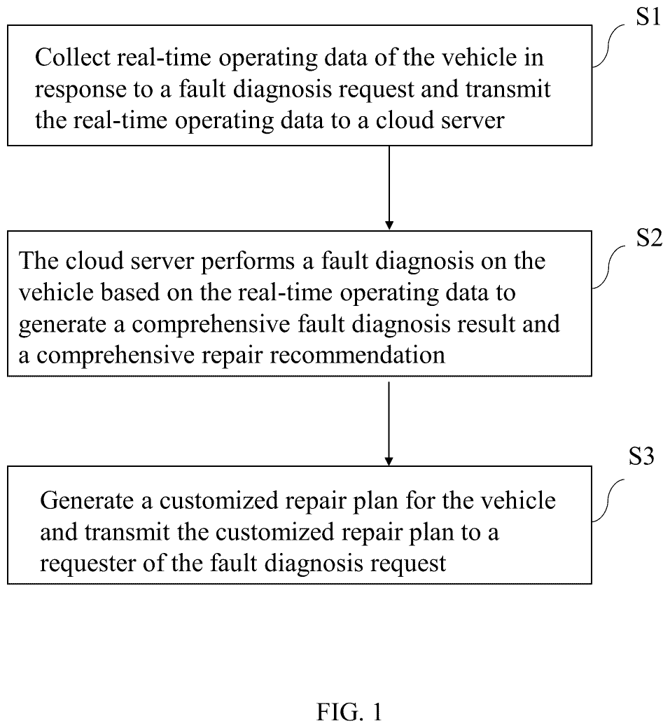

FIG. 1 illustrates a flow chart of a method for generating repair recommendations for vehicles according to an embodiment of the present application. In some embodiments, the method depicted in FIG. 1 can comprise steps S1-S3. In step S1, in response to a fault diagnosis request, real-time operating data of the vehicle can be collected and transmitted to a cloud server. In step S2, the cloud server can perform s fault diagnosis on the vehicle based on the real-time operating data to generate a comprehensive fault diagnosis result and a comprehensive repair recommendation. In step S3, a customized repair plan for the vehicle can be generated and transmitted to a requester of the fault diagnosis request. The customized repair plan can comprise the comprehensive fault diagnosis results and the comprehensive repair recommendation.

The initiator or requester of the fault diagnosis request in step S1 can be a user of the vehicle, an automotive mechanic of the vehicle, a manufacturer of the vehicle, or a third-party monitoring service provider. The fault diagnosis request can be issued regularly or triggered immediately upon detecting a specific fault. The real-time operation data of the vehicle can comprise, but is not limited to, the vehicle's mode, state, signal, and driving data. In some instances, the mode of the vehicle can comprise a driving mode of the vehicle, such as economy, sports, off-road, a manual driving mode and an automatic driving mode. The state of the vehicle can comprise starting, accelerating, decelerating, changing lanes, braking, and parking. The signal of the vehicle can comprise signals from various subsystems or components of the vehicle. The signal of the vehicle can be collected by on-board sensors. Subsystems can comprise a power system, a transmission system, a braking system, and a suspension system. Non-limiting examples of vehicle signals can comprise a battery temperature, a battery charge, an engine or motor temperature and speed, a transmission temperature and state, a braking system pressure and temperature, a suspension system pressure, a tire pressure, a wheel speed, and a steering angle. The driving data of the vehicle can comprise a current speed, an acceleration, a total mileage, a fuel or battery consumption rate, a navigation position, a driving route, a tire pressure status, a steering, and a lateral acceleration.

The data can be transmitted to a cloud platform in real time via an on-board diagnostic system (OBD) or other data interfaces. Examples of cloud platforms include, but are not limited to, Amazon AWS, Microsoft Azure, Google Cloud, IBM Cloud, Oracle Cloud, Alibaba Cloud, Tencent Cloud, and Huawei Cloud. These platforms can offer extensive computing power, edge computing support, and AI and big data processing capabilities. They can store and analyze large volumes of vehicle data, generate real-time customized feedback such as repair recommendations and driving behavior adjustments, and support various machine learning models for fault prediction and preventive maintenance. Additionally, the cloud platform can integrate with the on-board diagnostic system through APIs to enable automated fault diagnosis and deliver repair solutions.

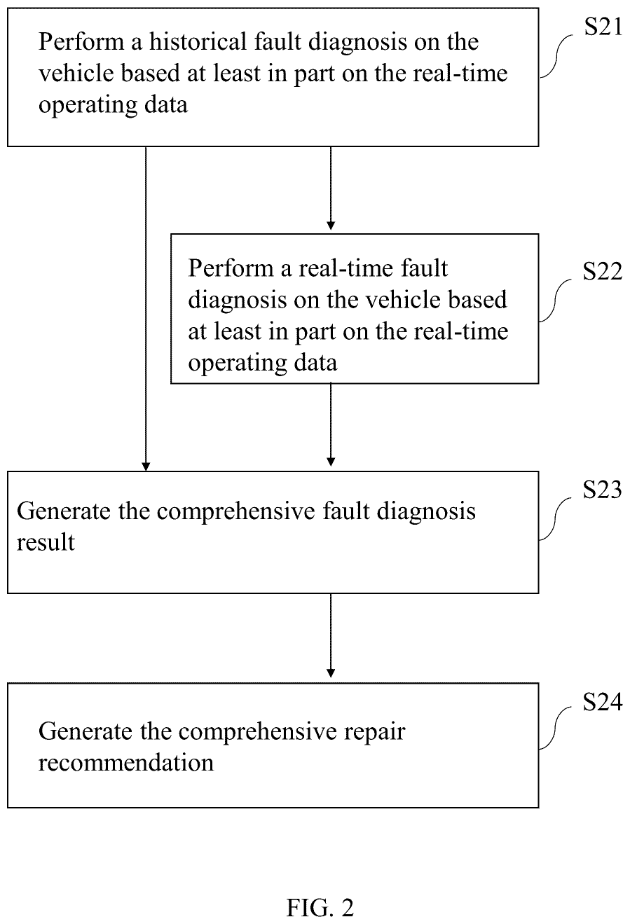

In some embodiments, as illustrated in FIG. 2, the step 2 on which the cloud server performs fault diagnosis on the vehicle using real-time operational data to generate a comprehensive fault diagnosis result and a comprehensive repair recommendation can comprise steps S21-S24. FIG. 2 is a flow chart depicting a method for generating a comprehensive fault diagnosis result and a comprehensive repair recommendation according to an embodiment of the present application.

In some embodiments, the step S21 can comprise performing a historical fault diagnosis for the vehicle based on the real-time operation data to generate a first fault diagnosis result (Res1) and a first repair recommendation (Sug1). The cloud server can store and update the vehicle's historical fault table (Ta), production batch-related fault table (Tb), and model-related fault table (Tc). The historical fault diagnosis in step S21 can be performed in a specific sequence: first, using a historical fault information; next, using a historical fault information of a production batch; and finally, using a historical fault information of a model of the vehicle. For instance, if the vehicle previously had a “low battery voltage” fault with a corresponding repair record, a checking for sensor data indicating a “low battery voltage” fault in the real-time operation data can be prioritized. Similarly, if other vehicles in the same production batch were previously reported with an “engine temperature sensor abnormality” fault with corresponding repair records, a checking for sensor data indicating an “engine temperature sensor abnormality” fault can be then performed for the vehicle. Likewise, if vehicles of the same model previously experienced a “brake fluid volume abnormality” fault with corresponding repair records, a checking for the “brake fluid volume abnormality” fault in the real-time data can be then performed for the vehicle. By focusing on faults that have occurred multiple times in the historical records of similar models or production batches, the method of the disclosure can effectively identify and diagnose recurring issues.

In some embodiments, to mitigate an impact of occasional faults on the historical fault diagnosis, the historical fault diagnosis can be performed for faults that have a fault count or frequency exceeding a threshold in the historical fault table (Ta), the production batch-related fault table (Tb), and the model-related fault table (Tc). To enhance a diagnostic accuracy, the threshold can be an adaptive threshold which is dynamically adjusted based on different vehicles, usage environments, and operating conditions. In some instances, the threshold can be automatically adjusted based on changes in the vehicle's operating environment (such as temperature, humidity, altitude) to account for the likelihood of faults under varying conditions. For instance, in a high-temperature environment, the threshold for abnormal battery voltage may require greater sensitivity, whereas in a cold environment, the threshold for engine start issues may require adjustments. For instance, the threshold can be adjusted in real-time based on the vehicle's actual operation (such as prolonged low-speed driving or frequent braking). The method of the disclosure can enable a continuous optimization of threshold settings using a machine learning algorithm. By analyzing vehicle operation data across different environments, the machine learning model can enhance its fault prediction capabilities and refine the threshold adjustment strategy in a progressive manner. For example, by comparing occurrence of faults in different vehicles under similar conditions, the method of the disclosure can learn the optimal threshold settings to minimize misjudgments and missed diagnoses.

Some faults may have minimal impact on vehicle safety or performance, while others can potentially lead to serious consequences. In some instances, different weights can be assigned to various fault types to optimize diagnostic efficiency. Faults with low frequencies but potentially severe impacts can be prioritized for diagnosis and processing, even if they do not meet the threshold.

In the event that a historical fault is identified as having recurred, the corresponding fault count in the historical fault table (Ta) can be updated, for example, by incrementing the number of faults by 1. Similarly, if a production batch-related fault recurs, the fault count corresponding to that fault in the production batch-related fault table (Tb) is updated. Likewise, if a vehicle model-related fault recurs, the fault count corresponding to that fault in the model-related fault table (Tc) is updated.

In some embodiments, the historical fault diagnosis of the vehicle, based at least in part on the real-time operation data in step S21, can comprise retrieving a historical fault data that is identical or similar to the vehicle's real-time data from the historical fault table (Ta), the production batch-related fault table (Tb), and/or the model-related fault table (Tc). This search can be implemented using case-based reasoning (CBR). In some examples, the method of the disclosure can extract features from the vehicle's real-time operation data and compare the extracted features with features of data in the historical fault table (Ta), the production batch-related fault table (Tb), and/or the model-related fault table (Tc) to find similar historical fault data that is similar to the vehicle's real-time operation data. The similarity comparison between data can be performed using feature matching algorithms, weighted vector algorithms, and multidimensional data space mapping methods. In the feature matching algorithm, the matching weight can be dynamically adjusted to accommodate different fault types and models. In the weighted vector algorithm, the weight can be adjusted based on the importance of each fault data to improve retrieval accuracy.

The advantage of storing and updating the historical fault table (Ta), production batch-related fault table (Tb), and model-related fault table (Tc) in the cloud server is that it allows for continuous optimization of the diagnostic capabilities. This can be achieved by accumulating new cases, enabling a self-learning of fault detection, and improving accuracy in the fault detection. In some embodiments, the historical fault diagnosis in step S21 can be performed with additional data sources in addition to the historical faults, production batch-related faults, and vehicle model-related faults. The additional data sources can include information regarding the driver's driving behavior (e.g., the driver's acceleration and braking patterns) and environmental conditions (e.g., climate, road conditions, and temperature). The additional data can facilitate a comprehensive analysis of potential causes of current faults, optimization of the fault diagnosis process, and enhancement of the adaptability across various scenarios. For example, if a vehicle has experienced difficulties in starting in cold weather multiple times, the method of the disclosure can be capable of considering not only historical faults, production batch-related faults, and vehicle model-related faults, but also dynamic data such as ambient temperature changes (e.g., prolonged sub-zero temperatures) and the driver's driving behavior (e.g., frequent short-distance driving or sudden acceleration, which may result in excessive battery consumption or increased engine load). The incorporation of these dynamic data into the fault diagnosis can enable the method of the disclosure to identify potential battery or fuel system faults with greater accuracy. The dynamic data can be obtained from the vehicle's sensor system or from external sources, including public weather forecast systems, traffic dispatch systems, and navigation systems. The integration of these dynamic dataset can enable the method of the disclosure to more accurately identify the root cause of faults and provide appropriate repair recommendations or preventive measures. As an additional example, if a vehicle is subject to frequent braking in an environment with elevated temperature, this may result in the abnormal wear of brake pads. In this scenario, when performing the historical and/or real-time fault diagnosis, the method of the disclosure can retrieve the vehicle's historical faults, production batch-related faults, and model-related faults, as well as considering ambient temperature data (e.g., prolonged periods above 40° C.) and driving behavior (e.g., frequent abrupt braking). By integrating these dynamic data sets, the method of the disclosure can determine that high temperature and abrupt braking maneuvers have caused overheating or accelerated deterioration of the braking system. Such an analysis can assist in the identification of potential faults within the braking system, thereby suggesting that the driver modify the driving habits or conduct an inspection of the braking system.

In some embodiments, the historical fault table (Ta) can include the license plate number, production batch, model, fault information, fault count, abnormal operation data, fault location, fault source, and repair recommendations. The production batch-related fault table (Tb) can include the production batch, fault information, fault count, abnormal performance, fault source, and repair recommendations. The model-related fault table (Tc) can include the model, fault information, fault count, abnormal performance, fault source, and repair recommendations. In some instances, the cloud server can initially be configured to store only the historical fault table (Ta). In the event of a fault, the production batch-related fault table (Tb) and model-related fault table (Tc) can be generated by aggregating data from the historical fault table (Ta). In generating the production batch-related fault table (Tb) and model-related fault table (Tc), additional dimensions such as environmental factors and vehicle usage can be included to enhance the accuracy of fault source analysis. This approach can facilitate more intelligent and adaptable diagnosis processes, which are better able to accommodate different environmental conditions and vehicle usage scenarios. The data in the historical fault table (Ta), the production batch-related fault table (Tb), and the model-related fault table (Tc) can be utilized to support the operation of AI algorithms. For example, an analysis of historical fault data in the historical fault table (Ta) can facilitate an automatic identification of potential fault patterns and a generation of customized repair recommendations. For example, an analysis of the data in the production batch-related fault table (Tb) can identify that vehicles from a particular production batch are susceptible to a specific fault under certain conditions. Such an approach can facilitate the issuance of proactive warnings to other vehicles from the same batch, thereby enabling them to undertake preventive maintenance measures and reduce the likelihood of faults. For instance, a comparative analysis of the historical fault data from multiple vehicles within specific production batches and models can facilitate an investigation into the fault performance of different vehicles in analogous environments. This analysis can facilitate the development of a more comprehensive troubleshooting and repair strategy. Such functionality can offer assistance to manufacturers in the management of large-scale fleets and the implementation of product improvements.

In some instances, the first fault diagnosis result (Res1) can provide comprehensive descriptions of an abnormal operation data, a location of fault, and a source of fault. For example, the Res1 can indicate that the abnormal operation data is a “low battery charge signal,” the location of fault is the “battery pack,” and the source of fault is “insufficient charging,” “prolonged use,” “reduced battery capacity,” or “low rated capacity.” The structured result can facilitate a quick identification of the fault and a formulation of appropriate repair plans. In some instances, a format of the first fault diagnosis result (Res1) can adhere to a predefined template. For example, the first fault diagnosis result (Res1) can comprise sensor readings, timestamps, and occurrence frequencies. Furthermore, the first repair recommendation (Sug1) can comprise details such as the location of the faulty component and suggested repair measures.

In step S22, a real-time fault diagnosis can be performed on the vehicle based on the real-time operational data of the vehicle to generate a second fault diagnosis result (Res2) and a second repair recommendation (Sug2). The second fault diagnosis result (Res2) can include an abnormal operation data, a location of fault, and possible causes of fault. The real-time fault diagnosis of the disclosure can be performed based on a knowledge graph or a fault diagnosis model. The second repair recommendation (Sug2) can be generated based on the information provided in the second fault diagnosis result (Res2). The second repair recommendation (Sug2) can include a description of fault symptoms, an image of the faulty component, a description of the repair approach, a video of the repair approach, or any combination thereof. The description of fault symptoms can enable users or automotive mechanics to determine the correlation between the fault and the observed performance with greater precision. Such description can include common symptoms and specific fault occurrence scenarios (e.g., performance during acceleration and braking), thereby enhancing the practicality of the information. The image of the faulty component can facilitate a rapid identification of the issue, which can then be cross-referenced with the vehicle's structural diagram to obtain a more intuitive visual understanding. The description of the repair approach can offer a text guidance for the repair operations, while the video of the repair approach can provide a teaching video for users or mechanics to follow to order to repair the faulty component.

In some embodiments, the real-time fault diagnosis in step S22 is based not only on the vehicle's real-time operation data but also on data from other sources, such as the road environment, climate conditions, and driving behavior. The integration of these additional data sources can serve to further enhance the accuracy of the fault diagnosis. In some instances, high-frequency faults or faults with serious impacts can be prioritized through a comprehensive analysis of real-time and historical data. The diagnostic priority can be automatically adjusted by assigning weights and scores to different types of faults. This process can be implemented using a machine learning algorithm.

In some embodiments, if the historical fault diagnosis in step S21 determines that a fault identical to a historical fault has occurred, the real-time fault diagnosis step S22 can be skipped. This decision can enhance an efficiency of fault detection and avoid redundant diagnostic work, thereby conserving time and resources. This can be particularly advantageous for vehicle models that frequently experience the same faults, as it effectively reduces the time required for repairs. In some instances, the determination to bypass the real-time fault diagnosis can be made based on vehicle usage or user feedback. For example, if the user reports recent changes in their driving pattern or environmental conditions, the real-time diagnosis can still be performed to identify the presence of any emerging issues. If the historical fault diagnosis in step S21 determines that no identical historical fault has occurred, the real-time fault diagnosis step S22 can be performed.

In step S23, a comprehensive fault diagnosis result can be generated. Depending on whether the real-time fault diagnosis in step S22 is performed, the comprehensive fault diagnosis result can include the first fault diagnosis result (Res1) and/or the second fault diagnosis result (Res2). In step S24, a comprehensive repair recommendation can be generated. Similarly, depending on whether the real-time fault diagnosis in step S22 is performed, the comprehensive repair recommendation can include the first repair recommendation (Sug1) and/or the second repair recommendation (Sug2). In some instances, the method of the disclosure can remove duplicate or invalid data from the first fault diagnosis result (Res1) and the second fault diagnosis result (Res2) and/or the first repair recommendation (Sug1) and the second repair recommendation (Sug2) using techniques such as data cleaning and feature selection, thereby reducing redundancy and enhancing diagnostic efficiency. For example, a deduplication algorithm or similarity detection algorithm can be used to ensure that only distinctive fault diagnosis information and repair recommendations are retained. In some instances, the method of the disclosure can integrate multiple fault diagnosis results or repair recommendations into a global view through multi-source data fusion. The fusion method can employ techniques such as weighted averaging or Bayesian reasoning to effectively combine different data sources, thereby generating more accurate fault diagnosis results and repair recommendations. In some instances, the method of the disclosure can predict or identify potential faults by analyzing the hidden patterns or associations in existing data through data mining and machine learning algorithms. This can be achieved using techniques such as anomaly detection and cluster analysis, thereby enhancing the efficacy of preventive maintenance strategies.

To facilitate a rapid identification of suitable repair solutions by different personnel (e.g., vehicle drivers, automotive mechanics, and manufacturer's development and design engineers), the method for generating vehicle repair recommendations of the disclosure can provide customized recommendations for vehicle drivers, automotive mechanics, and manufacturer's development and design engineers, respectively. The customized recommendations can ensure that each related personnel promptly access relevant solutions, thereby improving the efficiency of troubleshooting. In some embodiments, the comprehensive repair recommendation can be classified into operational guidance recommendations, hardware repair recommendations, and software/hardware improvement recommendations. This classification can be performed using a repair recommendation classifier. The repair recommendation classifier can comprise a variety of machine learning algorithms, including decision trees, K-nearest neighbor algorithms, support vector machines, logistic regression, and naive Bayes classifiers. The user feedback can be continuously collected, and the repair recommendation classifier can be updated in real-time based on the actual repair outcomes.

In step S3, a customized repair plan for the vehicle can be generated and transmitted to the requester of the fault diagnosis request. The requester can be the vehicle's user, an automotive mechanic, the vehicle's manufacturer, or a third-party monitoring service provider. The customized repair plan can include the comprehensive fault diagnosis results and the comprehensive repair recommendations. In some embodiments, to ensure the relevance and effectiveness, the customized repair plan can be formulated based on the vehicle's historical repair records, the severity and nature of the current fault, and dynamic data such as driving habits, environmental factors, and road conditions. The dynamic data can be derived from the vehicle's sensor system or external sources, including public weather forecasts, traffic dispatch systems, and navigation systems.

The customized repair plan can delineate the operational procedures for each recommendation, thereby facilitating the user's comprehension of the procedures. The customized repair plan can be delivered through various channels, including email, mobile app notifications, or SMS, to ensure a real-time receipt. The requester can provide feedback on the customized repair plan to enhance the accuracy of future recommendations. In some instances, the comprehensive fault diagnosis results and vehicle operating guidance can be transmitted to the vehicle user. Such recommendations can include modifications to driving habits or the implementation of regular inspections of specific components. The comprehensive fault diagnosis results and hardware repair recommendations can be transmitted to the automotive mechanic, detailing specifics of part replacements or sensor calibrations. Moreover, the comprehensive fault diagnosis results and the software/hardware improvement recommendations can be transmitted to the vehicle manufacturer's engineers. The software/hardware improvement recommendations can include updating software versions or fixing specific code issues.

In an example, when generating a customized repair plan for an electric vehicle, if it is determined that (i) the vehicle's historical repair records indicate multiple instances of battery overheating, (ii) the current fault “battery temperature abnormality” is classified as medium severity, (iii) the driver frequently engages in fast charging, and (iv) the vehicle is currently in a high temperatures area, the customized repair plan generated by the method of the disclosure can include repair recommendations “check the coolant level in the cooling system” and “inspect each cell of the battery pack for damage or failure”, which are transmitted to the automotive mechanic. Furthermore, the customized repair plan can include operational guidance for the vehicle's driver. Such operational guidance can include recommendations to reduce the frequency of fast charging, to avoid charging in high-temperature environments, and to regularly check the battery cooling system.

In another example, when generating a customized repair plan for a vehicle, if it is determined that (i) the vehicle's historical repair records indicate multiple instances of brake pad replacement, (ii) the current fault “insufficient brake pad thickness” is classified as urgent, (iii) the driver frequently drives in urban congestion, leading to repeated emergency braking, and (iv) the road surface in the vicinity of the vehicle is currently icy, the customized repair plan generated by the method of the disclosure can include repair recommendations “replace brake pads” and “inspect brake fluid”, which are transmitted to the automotive mechanic. Furthermore, the customized repair plan can include operational guidance for the vehicle's driver and software/hardware improvement recommendations for the vehicle manufacturer. The operational guidance can include recommendations to alert the driver to the frequent emergency braking over the next months. The software/hardware improvement recommendations can include the upgrading of software to optimize the electronic control strategy and early warning functions of the braking system.

The disclosure also provides a system including one or more computer processors and a computer readable memory. The computer readable memory can include machine executable code, which implements the method for generating repair recommendations for vehicles of the disclosure when executed by the one or more computer processors.

While preferred embodiments of the present invention have been shown and described herein, it will be obvious to those skilled in the art that such embodiments are provided by way of example only. Numerous variations, changes, and substitutions will occur to those skilled in the art without departing from the invention.

What is claimed is:

1. A method for generating a repair recommendation for a vehicle, the method comprising:
(S1) collecting a real-time operating data of the vehicle in response to a fault diagnosis request and transmitting the real-time operating data to a cloud server;
(S2) the cloud server performing a fault diagnosis on the vehicle based on the real-time operating data to generate a comprehensive fault diagnosis result and a comprehensive repair recommendation, the step S2 comprising:
(S21) performing a historical fault diagnosis on the vehicle based at least in part on the real-time operating data to generate a first fault diagnosis result Res1 and a first repair recommendation Sug1, and/or (S22) performing a real-time fault diagnosis on the vehicle based at least in part on the real-time operating data to generate a second fault diagnosis result Res2 and a second repair recommendation Sug1;
(S23) generating the comprehensive fault diagnosis result, the comprehensive fault diagnosis result comprising the first fault diagnosis result Res1 and/or the second fault diagnosis result Res2; and
(S24) generating the comprehensive repair recommendation, wherein the comprehensive repair recommendation comprising the first repair recommendation Sug1 and/or the second repair recommendation Sug2, wherein the comprehensive repair recommendation is categorized into an operational guidance recommendation, a hardware repair recommendation and a software/hardware improvement recommendation using a repair recommendation classifier; and
(S3) the cloud server generating a customized repair plan for the vehicle and transmitting the customized repair plan to a requester of the fault diagnosis request, the customized repair plan comprising the comprehensive fault diagnosis result and the comprehensive repair recommendation.

2. The method of claim 1, wherein a historical fault table Ta, a production batch-related fault table Tb and a model-related fault table Tc of the vehicle are stored and updated in the cloud server, and
wherein in step S21, the historical fault diagnosis is performed sequentially using a historical fault information of the vehicle, a historical fault information of a production batch of the vehicle, and a historical fault information of a model of the vehicle in this order.

3. The method of claim 2, wherein in step S21, when a historical fault is determined to have reoccurred, a fault count corresponding to the historical fault is updated in the historical fault table Ta; when a production batch-related fault is determined to have reoccurred, a fault count corresponding to the production batch-related fault is updated in the production batch-related fault table Tb; and/or when a model-related fault is determined to have reoccurred, a fault count corresponding to the model-related fault is updated in the model-related fault table Tc.

4. The method of claim 2, wherein in step S21, the historical fault diagnosis is performed for faults having a fault count or frequency exceeding a threshold in the historical fault table Ta, the production batch-related fault table Tb or the model-related fault table Tc.

5. The method of claim 2, wherein in step S21 and/or S22, the historical fault diagnosis and/or the real-time fault diagnosis is further performed based on a dynamic data, the dynamic data comprising a driving behavior data and/or an environmental data.

6. The method of claim 2, wherein the historical fault table Ta stores therein a license plate number, a production batch, a model, a fault information, a fault count, an abnormal operation data, a location of fault, a source of fault and a repair recommendation corresponding to the fault information,
wherein the production batch-related fault table Tb stores therein a production batch, a fault information, a fault count, an abnormal performance, a source of fault and a repair recommendation, and
wherein the model-related fault table Tc stores therein a model, a fault information, a fault count, an abnormal performance, a source of fault and a repair recommendation.

7. The method of claim 1, wherein the second fault diagnosis result Res2 comprises an abnormal operation data, a location of fault, a possible source of fault, and wherein the second repair recommendation Sug2 comprises a description of fault symptom, an image of faulty component, a description of repair approach, a video of repair approach and any combination thereof.

8. The method of claim 1, wherein in step S3, the comprehensive repair recommendation is transmitted to the requester of the fault diagnosis request along with the comprehensive fault diagnosis result.

9. The method of claim 1, wherein in step S3, the comprehensive fault diagnosis result and the operational guidance recommendation are transmitted to a user of the vehicle, the comprehensive fault diagnosis result and the hardware repair recommendation are transmitted to an automotive mechanic of the vehicle, and the comprehensive fault diagnosis result and the software/hardware improvement recommendation are transmitted to a manufacturer of the vehicle.

10. The method of claim 2, further comprising utilizing a big data analytics to update the production batch-related fault table Tb and the model-related fault table Tc of the vehicle in the cloud server.

11. The method of claim 2, wherein the production batch-related fault table Tb and the model-related fault table Tc are generated by aggregating data from the historical fault table Ta.

12. The method of claim 4, wherein a machine learning algorithm is utilized to adjust the threshold in real time based on changes in an operating environment of the vehicle and/or an actual operating condition of the vehicle.

13. The method of claim 1, wherein when the historical fault diagnosis in step S21 identifies a fault that is identical to a historical fault, the real-time fault diagnosis of step S22 is bypassed.

14. The method of claim 1, wherein a decision to perform the real-time fault diagnosis in step S22 is based on a usage of the vehicle or feedback from a user of the vehicle.

15. The method of claim 1, further comprising collecting a user feedback to dynamically update the repair recommendation classifier.

16. The method of claim 1, wherein step S23 and/or step S24 further comprises removing duplicate or invalid data in the first fault diagnosis result Res1 and the second fault diagnosis result Res2 and/or the first repair recommendation Sug1 and the second repair recommendation Sug2 by using a data cleaning or a feature selection.

17. The method of claim 1, wherein step S23 and/or step S24 further comprises integrating the first fault diagnosis result Res1 and the second fault diagnosis result Res2 and/or the first repair recommendation Sug1 and the second repair recommendation Sug2 into a global view by a multi-source data fusion.

18. The method of claim 1, wherein step S3 comprises generating the customized repair plan based on the comprehensive fault diagnosis result, a severity and a type of current fault, and a dynamic data, the dynamic data comprising a driving behavior data and/or an environmental data.

19. The method of claim 18, wherein the dynamic data is received from a sensor system of the vehicle and/or an external data source.

20. A system comprising one or more computer processors and a computer readable memory, the computer readable memory comprising machine executable code, which when executed by the one or more computer processors implements the method for generating repair recommendations for a vehicle of claim 1.
